(19) United States
(12) Patent Application Publication
(10) Pub. No.: US 2024/0149935 A1
(43) Pub. Date: May 9, 2024

(54) ELECTRIC HEATING ARRANGEMENT AND METHODS FOR MANUFACTURING AN ELECTRIC HEATING ARRANGEMENT

(71) Applicant: IEE INTERNATIONAL ELECTRONICS & ENGINEERING S.A., ECHTERNACH (LU)

(72) Inventor: Frank ALTHAUS, Saarbrücken (DE)

(21) Appl. No.: 18/284,268

(22) PCT Filed: Mar. 25, 2022
(86) PCT No.: PCT/EP2022/057865

§ 371 Date: Sep. 26, 2023

(30) Foreign Application Priority Data
Mar. 26, 2021 (LU) LU102726
Jul. 7, 2021 (LU) LU500404

(51) Int. Cl. B62D 1/06; H05B 3/34

(52) U.S. Cl. CPC B62D 1/065; H05B 3/342; H05B 2203/003; H05B 2203/007; H05B 2203/017

(57) ABSTRACT

An electric heating arrangement having a planar substrate and an electrically conductive heating track arranged on a surface of the substrate. The heating track includes at least a first heating track section and a second heating track section separated from each other by a gap and extending at a distance along each other on the substrate. The electric heating arrangement further includes a layer of thermally conductive material arranged on the surface of the substrate in the gap between the first heating track section and the second heating track section. A width of the layer of thermally conductive material is smaller than a width of the gap between the first heating track section and second heating track section. The layer of thermally conductive material is arranged so as to be separated from the first heating track section and the second heating track section.

### TECHNICAL FIELD

The invention relates to an electric heating arrangement, in particular for automotive applications, and methods of manufacturing such an electric heating arrangement.

### BACKGROUND

Electric heating arrangements are widely used in the automotive industry. Usually, such electric heating arrangements are used for heating up a specific component of a vehicle, such as e.g. a steering wheel, a portion of the passenger seat, an arm rest or similar, comfort offering components. Electrical heating arrangements may for example in particular be used for heating up components when a vehicle has to be started in cold conditions. An essential necessity of such heating devices is that they should not be visible or perceptible for a vehicle user as long said heating arrangement is not in operation. Generally, an electrical heating arrangement may be integrated in or covered by another component, for example a trim cover of a steering wheel.

It is another requirement to provide for an even heating up after the heating device has been activated, e.g. a heating up following a predeterminable heat rate of several degrees Celsius in a specified time interval. An even heating up prevents the generation of hot spots and/or cold areas. These requirements generally disenable the use of conventional heating wires such as wires based on copper or copper-nickel-(manganese) based alloys, which provide a rather low resistivity temperature dependence and which might also be perceived by a driver. However, such heating devices are widely used in prior art.

### SUMMARY

It is therefore desirable to provide an improved electrical heating arrangement, in particular an electric heating arrangement for an automotive application, wherein said heating arrangement prevents the occurrence of hot spots during its operation whilst being less perceptible. This object is achieved by the subject-matter of the independent claims.

In one aspect, the object is achieved by an electric heating arrangement comprising a planar substrate, an electrically conductive heating track arranged on a surface of said substrate, said electrically conductive heating track being connectable to a current source so that in operation a heating current flows through said electrically conductive heating track. The electrically conductive heating track comprises at least a first heating track section and a second heating track section extending at a distance along each other on said substrate, whereby a gap is formed between said first heating track section and the second heating track section. The electric heating arrangement further comprises a layer of thermally conductive material arranged on said surface of the substrate in said gap between the first heating track section and the second heating track section, wherein a width of said layer of thermally conductive material is smaller than a width of said gap between said first heating track section and second heating track section; and wherein said layer of thermally conductive material is arranged so as to be separated from said first heating track section and said second heating track section.

The term “substrate” generally refers to a material having a flat shape and configured to support the electrically conductive heating track. The substrate may e.g. comprise a plastic foil comprising at least one of the following: polyethylene terephthalate (PET), thermoplastic polyurethane (TPU), Polyurethane (PU), a plastic, a polymer, or mixtures thereof.

The term “separated” generally refers to a spatial separation or an isolation. Due to the different widths, a channel-like structure is formed between the layer of thermally conductive material and first heating track section and the second heating track section. As a consequence, the layer of thermally conductive material may be spatially separated and electrically isolated from the electrically conductive heating track, respectively the first and the second heating track sections.

One advantage of the proposed electric heating arrangement is that its structure is less perceivable to a user. Due to the layer of thermally conductive material filled in the gap between the first heating track section and the second heating track section, a depth generating a perceivable curvature between the adjacent heating tracks is not present. The heating arrangement may also be advantageously installed underneath a cover, such as for example a textile steering wheel cover.

Due to the layer of thermally conductive material arranged between the heating track sections, one further advantage of the proposed electric heating arrangement is that an enhanced homogeneity in terms of heat dissipation is provided. The thermally conductive material on the substrate between the heating tracks may provide a function similar to a thermal bridge. The thermally conductive layer facilitates a heat transfer originating from the heating tracks and/or the heated substrate by providing a path of merely small resistance for said heat transfer, e.g. a heat transfer based on conduction. As a consequence, the thermal resistance of the electric heating arrangement is lowered and the heat energy provided by the heating tracks may be dissipated evenly via the thermally conductive material, respectively a surface of said material. As a result, the generation of hot spots caused by the heating tracks, and/or cold areas caused by the gaps is lessened or entirely prevented.

The present invention is in particular usable in the field of automotive applications, but could also be used with advantage in building construction or in medical applications. The term “automotive”, as used in this patent application, shall particularly be understood as being suitable for use in vehicles including passenger cars, trucks, semi-trailer trucks and buses.

In preferred embodiments, a thickness of the layer of thermally conductive material and a thickness of the first heating track section and/or the second heating track section are substantially equal. The term “thickness” may refer to a height dimension of a heating track with respect to the surface of the substrate. Due to the same thickness of the layer of thermally conductive material and the first heating track section and/or the second heating track section, the electric heating arrangement is less perceivable by a user. Furthermore, a uniform thickness may also result in a more uniform heat dissipation.

In preferred embodiments, the substrate comprises a textile or a foil. The use of a textile or foil may enhance the stretchability, respectively the extensibility, and the flexibility of the heating arrangement. As a result, a mounting of said heating arrangement on another component, such as e.g. a steer wheel, is facilitated.

In preferred embodiments, the electrically conductive heating track comprises at least one of the following: Cu, Ni, Ag, Al, or mixtures thereof. A heating track comprising Copper (Cu), Nickel (Ni), Silver (Ag) or Aluminum (Al) provides an enhanced electrical and thermal conductivity.

In embodiments, an insulating material may be arranged on the surface of the substrate between the layer of thermally conductive material and the first heating track section and/or the second heating track section. The insulating material may have a rather weak thermal insulating property, such that a specific predeterminable amount of heat may dissipate through said insulating material. In addition, the insulating material may additionally prevent shortcuts between the layer of thermally conductive material and the first heating track section and/or the second heating track section. Furthermore, the arrangement of an insulating material on the surface of the substrate between the layer of thermally conductive material and the first heating track may further contribute to the prevention of a perceivable unevenness, respectively a curvature.

In preferred embodiments, each of the first heating track section and the second heating track section has a wavelike shape extending along a length direction of the electric heating arrangement. The term “length direction” may refer to a direction defined by a length dimension of the electric heating arrangement. The wavelike shape may further increase the stretchability of the heating arrangement. In addition, said wavelike shape further enhances a uniform heat dissipation.

In preferred embodiments, the first heating track section has an inner radius with respect to an inner apex at a first edge of said heating track section, wherein said inner radius extends over a portion of the first heating track section to a second edge of the first heating track section; and wherein the first heating track section has an outer radius with respect to an outer apex at the second edge, wherein said outer radius (R2) extends over a portion of the gap to a first edge of the second heating track section; and wherein the inner radius (R1) and the outer radius (R2) are equal. The term “apex” may refer to a peak point on the edge of a heating track section. For example, an apex can be a point on the edge at which the edge does not have a slope. The mathematical term “slope”, respectively gradient, may refer to a number describing the direction and the steepness of a line. The inner radius may extend from a first edge of the first heating track section over a portion of said first heating track section. Further for example, the inner apex and the outer apex may be aligned to one another. The outer radius may extend from a second edge of the first heating track section over a portion of the gap, respectively the thermally conductive material arranged in the gap, to a first edge of the second heating track section. This arrangement may allow a particularly uniform heat transfer from the heating track sections to the thermally conductive material, whilst further enhancing the stretchability.

In preferred embodiments, the electrically conductive heating track comprises a plurality of heating traces electrically connected in parallel to one another, wherein a first heating trace of the plurality of heating traces comprises the first heating track section, and wherein a second heating trace of the plurality of heating traces comprises the second heating track section. The arrangement of several heating traces may further enhance a particularly fast heat dissipation.

In preferred embodiments, the electrically conductive heating track has a meandering shape or a U-shape, wherein the first heating track section and the second heating track section are formed by adjacent branches of said meandering shape or U-shape. The first heating track section and the second heating track section may each form a branch, respectively a segment, of the meandering shape or the U-shape. The meandering shape or U-shape of the heating track allows a comparatively large coverage of an area to be heated.

In another aspect of the invention, the object is achieved by a steering wheel heater for an automotive application comprising an electric heating arrangement according to the invention. The steering wheel heater further comprises a current source connectable to contact terminals of the electrically conductive heating track and a control unit configured for connecting said current source to said terminals for controlling a heating operation in accordance.

The benefits described in context with the proposed electric heating arrangement in accordance with the invention apply also to the proposed steering wheel heater to the full extent.

The invention also concerns a method for manufacturing an electric heating arrangement, the method comprising at least the following steps: applying an electrically conductive heating track on a surface of said substrate, said electrically conductive heating track comprising at least a first heating track section and a second heating track section extending at a distance along each other on said substrate, whereby a gap is formed between said first heating track section and the second heating track section. The method further comprises applying a layer of a thermally conductive material on said surface of the substrate in said gap; wherein a width of said layer of thermally conductive material is smaller than a width of said gap between said first heating track section and second heating track section; and wherein said layer of thermally conductive material is located on the substrate so as to be separated from said first heating track section and said second heating track section.

The benefits described in context with the proposed electric heating arrangement in accordance with the invention apply also to the proposed method for manufacturing an electric heating arrangement to the full extent.

The invention also concerns a further method of manufacturing an electric heating arrangement, the method comprising at least the following steps: providing a planar substrate, and applying a layer of electrically conductive material on a surface of the substrate. The method further comprises selectively removing portions of said electrically conductive material so as to form an electrically conductive heating track comprising at least a first heating track section and a second heating track section extending at a distance along each other on said substrate, and an intermediate section of conductive material arranged between said first heating track section and said second heating track section. A width of said intermediate section of conductive material is smaller than a width of a gap between said first heating track section and second heating track section. Said selectively removing of electrically conductive material is performed in such a way that the intermediate section of conductive material is separated from said both said first heating track section and said second heating track section.

The term “intermediate section” may refer to a layer of thermally conductive material.

The benefits described in context with the proposed electric heating arrangement in accordance with the invention apply also to the further method for manufacturing an electric heating arrangement to the full extent.

In a preferred embodiment, the step of selectively removing of the electrically conductive material is carried out by using a cutting process, a laser cutting process, a partial kiss-cut process, a contour-cutting process or an etching process, whereby the electrically conductive material is at least partially cut or etched from an outside to the substrate. The term “outside” refers to a side of the electrically conductive material facing an exterior environment. The cutting process may cause a partial cut, which refers to a cut where the material to be cut is cut away to a predetermined depth.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies embodiments of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a section of a prior art heating device in a top view;

FIG. 2 schematically illustrates a cross-section through two adjacent heating lines of the prior art heating device pursuant to FIG. 1, wherein an additional cover is mounted on the heating device;

FIG. 3 schematically illustrates a section of a top view of an electric heating arrangement according to an embodiment of the invention;

FIG. 4 schematically illustrates a sectional view of FIG. 3, wherein two heating track sections and a layer of thermally conducive material are illustrated, and wherein a trim cover is mounted on the electric heating arrangement;

FIG. 5 schematically illustrates a top view of an electric heating arrangement according to another embodiment of the invention;

FIG. 6 schematically illustrates a top view of an electric heating arrangement comprised in a steering wheel heater;

FIG. 7 is a flowchart of a method in accordance with an embodiment of the invention of manufacturing the electric heating arrangement pursuant to any one of FIGS. 3 to 6.

FIG. 8 is a flowchart of another method in accordance with an embodiment of the invention of manufacturing the electric heating arrangement pursuant to any one of FIGS. 3 to 6.

### DETAILED DESCRIPTION

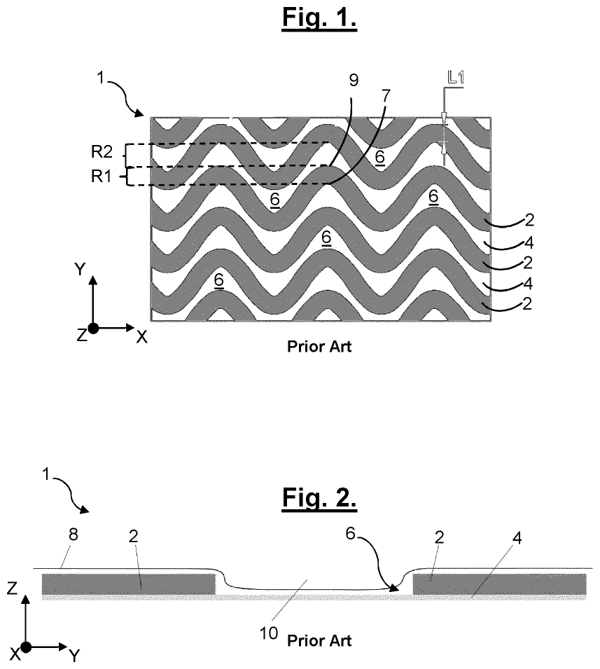

FIG. 1 is a schematic top view of a prior art heating device 1, wherein the heating device 1 consists of a plurality of electrically conductive heating lines 2 forming part of a heating track (not shown). The heating lines 2 are electrically connected in parallel. The heating lines 2 are disposed on a supporting substrate 4. The heating device further presents a plurality of recesses 6, wherein each recess is arranged in between two neighboring heating lines 2, thereby exposing the substrate 4. As can be further derived from FIG. 1, the heating lines 2 present an irregular serpentine-like shape along a direction parallel to a length direction X of the heating device 1. An inner radius R1 of a serpentine-like heating line 2 with respect to an inner apex 7 on a first edge of said heating line 2 is different from an outer radius R2 with respect to an outer apex 9. The width L1 of a heating line 2 slightly varies at each point along the heating line 2. In consequence, this heating device may be prone to the generation of hot spots and/or cold areas during operation of the heating arrangement 1.

FIG. 2 is a schematic sectional view of the prior art heating device 1 illustrated by FIG. 1, wherein two adjacently arranged heating lines 2 are illustrated. FIG. 2 also shows a trim cover 8 of a steering wheel (not shown) mounted on the heating device 1. As can be derived from FIG. 2, the absence of material within the recess 6 between the heating lines 2 causes the cover 8 to extend unevenly over the heating arrangement 1. As a consequence, the cover forms a curvature 10 at locations where the cover 8 contacts the substrate 4. These curvatures 10 are perceivable by a user and may also be prone to inhomogeneities of heat dissipation.

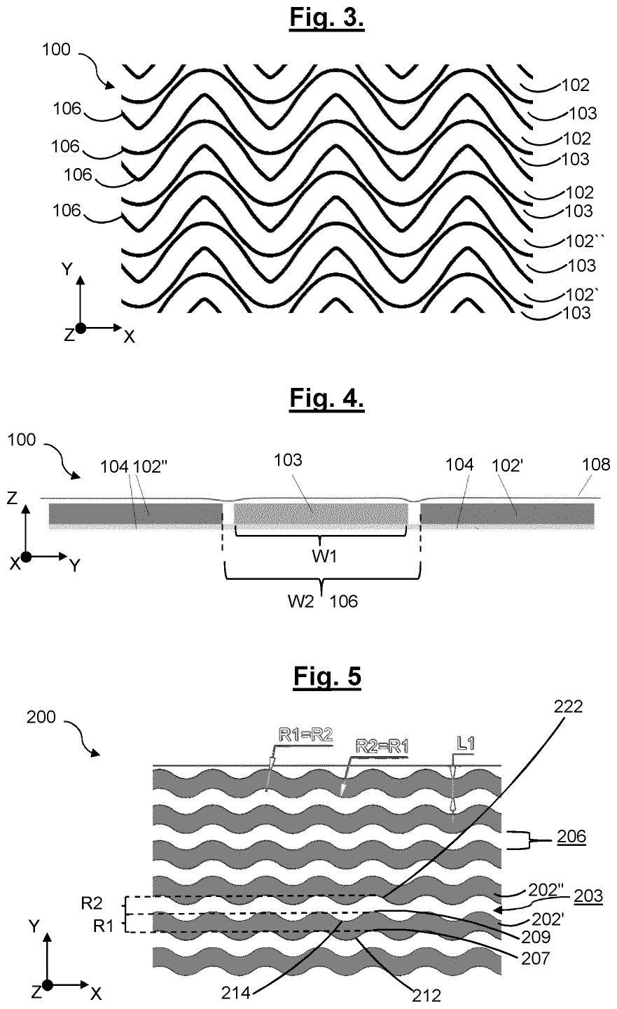

FIG. 3 is a schematic section of a top view of an electric heating arrangement 100 according to an embodiment of the invention. FIG. 4 is a schematic sectional view of the electric heating arrangement 100 illustrated by FIG. 3, wherein two heating track sections 102 and a layer of thermally conducive material 103 are illustrated. In addition, FIG. 4 shows a trim cover 108 mounted on the electric heating arrangement 100. The heating track sections 102 shown in the embodiment illustrated by FIG. 3 may be part of a single heating track, wherein said heating track sections 102 are connected to each other in parallel. The electrically conductive heating track is connectable to a current source (not shown), so that in operation a heating current flows through said electrically conductive heating track and the plurality of heating track sections 102.

Each heating track section 102 extends at a distance along a neighboring heating track section 102 on the substrate 104, whereby a gap 106 is formed, respectively defined, between the two spaced apart, neighboring heating track sections 102. This is also illustrated in FIGS. 3 and 4 by the first heating track 102′ and the second heating track section 102″. A layer of thermally conductive material 103 is arranged on said surface of the substrate 104 in said gap 106 between the heating track sections 102, respectively the first heating track section 102′ and the second heating track section 102″. The thickness of the layer of thermally conductive material 103 and the thickness of the heating track sections 102 are substantially equal. The substrate 104 comprises a flexible textile or a foil.

As can be derived from FIG. 4, the width W1 of said layer 103 of thermally conductive material is smaller than a width W2 of said gap 106 between the two heating track sections 102. The layer of thermally conductive material 103 is thus arranged so as to be separated from its adjacently arranged heating track sections, which is illustrated by the black linings in FIG. 3. In other words, a channel-like structure, respectively a narrow recess, is formed between an edge of the layer of thermally conductive material 103 and a corresponding, adjacent heating track section 102′, 102″. As a consequence, the layer of thermally conductive material 103 is electrically isolated from the adjacent heating track sections.

Due to the particularly small difference of the widths W1 and W2, as well as the thermal conductivity of the conductive layer 103, the heat emitted by the neighboring heating track sections 102 is absorbed by the layer of thermally conductive material 103 during operation of the heating arrangement 100. This results in a particular homogeneous heat dissipation.

It should be noted that the conductive layer 103 may be formed of the same material or a different material than the heating track. It should be further noted that each heating track section may have a width in a range of 2 mm to 10 mm, preferably in a range from 4 mm to 8 mm, most preferred of 6 mm. The wavelength is in a range of 12 mm to 18 mm, preferably in a range from 14 mm to 16 mm, most preferred of 15 mm.

As can be further derived from FIG. 4, a (trim) cover 108 of a steering wheel (not shown) expands evenly over the heating track sections as well as the conductive layer 103. The trim cover 108 may comprise an insulating material. Portions of the trim cover 108 protrude in the channel-like structures between the layer of thermally conductive material and an adjacent heating track section 102 on the surface of the substrate 104. As a consequence, the heating arrangement 100 is less or not at all perceivable by a user and the formation of curvatures is significantly reduced. In addition, said protruding portions of the trim cover may also provide an electric isolation between the layer of thermally conductive material 103 and the adjacent heating track sections 102. In alternative embodiments (not shown), merely an insulating material may be arranged on the surface of the substrate 104 between the layer of thermally conductive material 103 and the heating track sections.

FIG. 5 is a schematic top view of an electric heater arrangement 200 according to another embodiment of the invention. The embodiment illustrated by FIG. 5 is similar to the embodiment illustrated by FIGS. 3 and 4, except for the inner radius R1 and the outer radius R2, which are equal in the embodiment shown in FIG. 5. Each heating track section has a wavelike shape extending along a length direction X of the electric heating arrangement 200. In the embodiment illustrated by FIG. 5, a first heating track section 202′ has an inner radius R1 with respect to an inner apex 207 at a first edge 212 of said heating track section 202′. The inner radius R1 extends over a portion of the first heating track section 202′ to a second edge 214 of the first heating track section 202′. The first heating track section 202′ has also an outer radius R2 with respect to an outer apex 209 at the second edge 214 of said first heating track sections 202′. The outer radius R2 extends over a portion of the gap 206, respectively the layer of thermally conductive material 203 arranged within the gap 206, to a first edge 222 of the second heating track section 202″. Both, the inner radius R1 and the outer radius R2 may have an equal length in a range of 2 mm to 10 mm, preferably in a range from 4 mm to 8 mm, most preferred a length of 6 mm. Also, the width L1 of each heating track section 202 is constant. The width L1 is in a range of 2 mm to 10 mm.

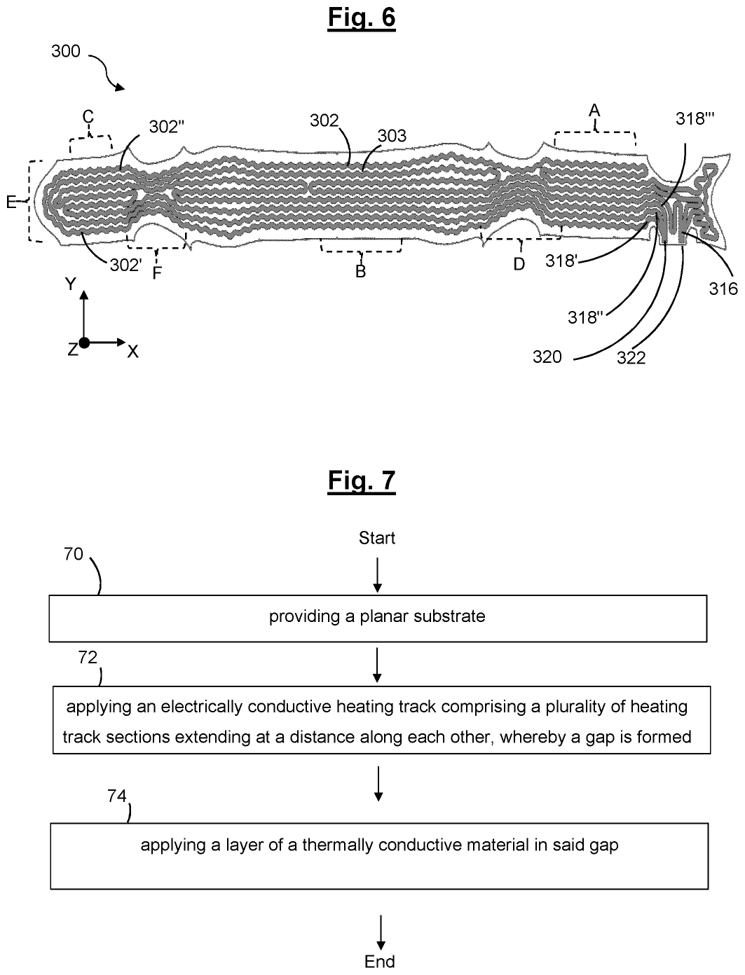

FIG. 6 illustrates in a schematic top view a further embodiment of an electric heating arrangement 300, respectively a steering wheel heater comprising an electric heating arrangement. The embodiment shown in FIG. 6 is adapted to be mounted on a steering wheel (not shown). The electric heating arrangement 300 comprises a plurality of sections A, B, C, each presenting a structure according to the embodiment illustrated in FIG. 5. As can be seen in e.g. section B, the layer of thermally conductive material 303 extends in a gap between neighboring heating track sections 302.

The electric heating arrangement 300 comprises an electrically conductive heating track 316 comprising a plurality of heating traces 318′, 318″, 318′″, wherein said heating traces are electrically connected to one another. The heating track has a meandering shape at sections D and F of the heating arrangement 300. In addition, the heating track has a U-shaped portion in section E. As can be derived from FIG. 7, the heating track 316 comprises the heating trace 318′ having an U-shaped portion which is at least partially formed by the first heating track section 302′ and the second heating track section 302″. The first heating track section 302′ and the second heating track section 302″ form both a branch of the U-shape. Due to the meandering shape and the U-shaped portions of the heating track, the electric heating arrangement uniformly dissipates heat over a particularly large areal.

The electric heating arrangement 300, respectively the steering wheel heater comprising the electric heating arrangement, may further have two contact terminals 320, 322. The two contact terminals 320, 322 are connectable to an electric current source. The contact terminals are arranged at end portions of the electrically conductive heating track 316. The contact terminals may be connected to a control unit (not shown) configured for connecting said current source to said terminals 320, 322 for controlling a heating operation in accordance.

FIG. 7 is a flowchart of a method of manufacturing the electric heating arrangement pursuant to any embodiment illustrated by FIGS. 3-6. Steps of the method will be described with reference to FIGS. 3 and 4.

The method of manufacturing an electric heating arrangement 100 comprises the following steps: In one step 70, a planar substrate is provided. In a further step 72, an electrically conductive heating track is applied on a surface of said substrate. The electrically conductive heating track comprises at least a first heating track section 102′ and a second heating track section 102″ extending at a distance along each other on said substrate 104, whereby a gap 106 is formed between said first heating track section 102′ and the second heating track section 102″.

In another step 74, a layer of a thermally conductive material 103 is applied on said surface of the substrate 104 in said gap 106, wherein a width W1 of said layer of thermally conductive material 103 is smaller than a width W2 of said gap 106 between said first heating track section 102′ and second heating track section 102″. The layer of thermally conductive material 103 is located on the substrate 104 so as to be separated from said first heating track section 102′ and said second heating track section 102″.

It should be noted that the steps 72 and 74 may be carried out simultaneously or subsequently. It should be further noted that the order of steps 72 and 74 may be altered.

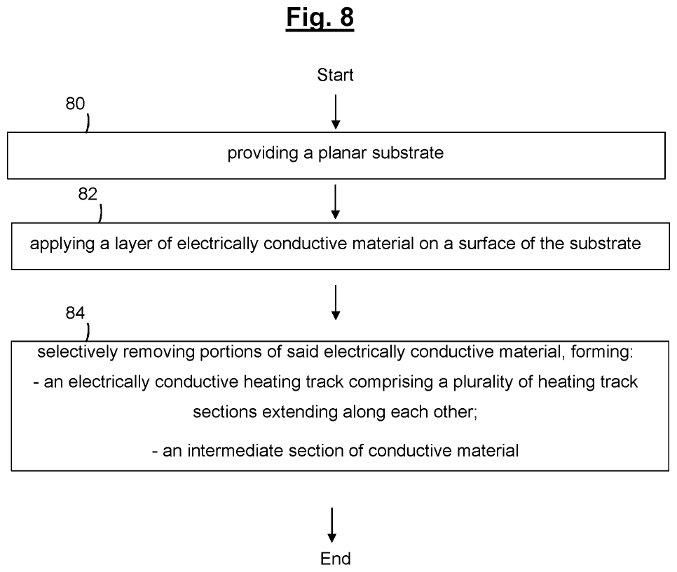

FIG. 8 is a flowchart of a further method of manufacturing the electric heating arrangement pursuant to any embodiment illustrated by FIGS. 3-6. Steps of the method will be described in the following with reference to FIGS. 3 and 4. The further method of manufacturing an electric heating arrangement comprises the following steps: In one step 80, a planar substrate 104 is provided. In a further step 82, a layer of electrically conductive material is applied on a surface of the substrate 104. In another step 84, portions of said electrically conductive material are selectively removed so as to form an electrically conductive heating track comprising at least a first heating track section 102′ and a second heating track section 102″ extending at a distance along each other on said substrate 104, and an intermediate section of conductive material 103 arranged between said first heating track section 102′ and said second heating track section 102″. The width W1 of said intermediate section of conductive material 103 is smaller than a width W2 of a gap 106 between said first heating track section 102′ and second heating track section 102″.

The step 84 of selectively removing of the electrically conductive material is performed in such a way that the intermediate section of conductive material 103 is separated from said both said first heating track section 102′ and said second heating track section 102″.

In a preferred embodiment, the step 84 of selectively removing of the electrically conductive material 103 is carried out by using a cutting process, a laser cutting process, a partial kiss-cut process, a contour-cutting process or an etching process, whereby the electrically conductive material is at least partially cut or etched from an outside to the substrate 104.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. An electric heating arrangement comprising:
a planar substrate; and
an electrically conductive heating track arranged on a surface of said substrate, said electrically conductive heating track being connectable to a current source so that in operation a heating current flows through said electrically conductive heating track, wherein said electrically conductive heating track comprises at least a first heating track section and a second heating track section extending at a distance along each other on said substrate, whereby a gap is formed between said first heating track section and the second heating track section;
wherein the electric heating arrangement further comprises a layer of thermally conductive material arranged on said surface of the substrate in said gap between the first heating track section and the second heating track section; wherein a width of said layer of thermally conductive material is smaller than a width of said gap between said first heating track section and second heating track section; and wherein said layer of thermally conductive material is arranged so as to be separated from said first heating track section and said second heating track section.

2. The electric heating arrangement according to claim 1, wherein a thickness of the layer of thermally conductive material and a thickness of the first heating track section and/or the second heating track section are substantially equal.

3. The electric heating arrangement according to claim 1, wherein the substrate comprises a textile or a foil.

4. The electric heating arrangement according to claim 1, wherein the electrically conductive heating track comprises at least one of the following: Cu, Ni, Ag, Al, or mixtures thereof.

5. The electric heating arrangement according to claim 1, wherein each of the first heating track section and the second heating track section has a wavelike shape extending along a length direction of the electric heating arrangement.

6. The electric heating arrangement according to claim 5, wherein the first heating track section has an inner radius with respect to an inner apex at a first edge of said heating track section, wherein said inner radius extends over a portion of the first heating track section to a second edge of the first heating track section; and wherein the first heating track section has an outer radius with respect to an outer apex at the second edge, wherein said outer radius extends over a portion of the gap to a first edge of the second heating track section; and wherein the inner radius and the outer radius are equal.

7. The electric heating arrangement according to claim 1, wherein the electrically conductive heating track comprises a plurality of heating traces electrically connected in parallel to one another, wherein a first heating trace of the plurality of heating traces comprises the first heating track section, and wherein a second heating trace of the plurality of heating traces comprises the second heating track section.

8. The electric heating arrangement according to claim 1, wherein the electrically conductive heating track has a meandering shape or a U-shape and wherein said first heating track section and said second heating track section are formed by adjacent branches of said meandering shape or a U-shape.

9. Steering wheel heater for an automotive application comprising the electric heating arrangement according to claim 1, the steering wheel heater further comprising a current source connectable to contact terminals of the electrically conductive heating track; and a control unit configured for connecting said current source to said terminals for controlling a heating operation of the steering wheel heater.

10. A method of manufacturing an electric heating arrangement, the method comprising at least the following steps:
providing a planar substrate;
applying an electrically conductive heating track on a surface of said substrate, said electrically conductive heating track comprising at least a first heating track section and a second heating track section extending at a distance along each other on said substrate, whereby a gap is formed between said first heating track section and the second heating track section; and
applying a layer of a thermally conductive material on said surface of the substrate in said gap; wherein a width of said layer of thermally conductive material is smaller than a width of said gap between said first heating track section and second heating track section; and wherein said layer of thermally conductive material is located on the substrate so as to be separated from said first heating track section and said second heating track section.

11. A method of manufacturing an electric heating arrangement, the method comprising at least the following steps:
providing a planar substrate;
applying a layer of electrically conductive material on a surface of the substrate; and
selectively removing portions of said electrically conductive material so as to form an electrically conductive heating track comprising at least a first heating track section and a second heating track section extending at a distance along each other on said substrate, and an intermediate section of conductive material arranged between said first heating track section and said second heating track section; wherein a width of said intermediate section of conductive material is smaller than a width of a gap between said first heating track section and second heating track section; and
wherein said selectively removing portions of said electrically conductive material is performed in such a way that the intermediate section of conductive material is separated from said both said first heating track section and said second heating track section.

12. The method according to claim 11, wherein the step of selectively removing portions of said electrically conductive material is carried out by using a cutting process, a laser cutting process, a partial kiss-cut process, a contour-cutting process or an etching process, whereby the electrically conductive material is at least partially cut or etched from an outside to the substrate.
